(19) United States
(12) Patent Application Publication
(10) Pub. No.: US 2026/0361595 A1
(43) Pub. Date: Nov. 12, 2026

(54) NETWORK MANAGEMENT APPARATUS, METHOD, AND PROGRAM

(71) Applicant: NTT, Inc., Tokyo (JP)

(72) Inventors: Kazuaki AKASHI, Tokyo (JP); Shunsuke KANAI, Tokyo (JP); Hiroaki MATSUBAYASHI, Tokyo (JP); Masashi KOBAYASHI, Tokyo (JP); Mayu YAMAZOE, Tokyo (JP)

(73) Assignee: NTT, Inc., Tokyo (JP)

(21) Appl. No.: 19/131,968

(22) PCT Filed: Dec. 7, 2022
(86) PCT No.: PCT/JP2022/045188

§ 371 Date: May 22, 2025

(51) Int. Cl. H04L 41/0663; G06F 1/30

(52) U.S. Cl. CPC H04L 41/0663; G06F 1/30

(57) ABSTRACT

A network management device includes a generation unit that generates a plan of work for power supply to a communication facility housed in a part of a plurality of structures when applying a condition assuming that a power outage has occurred in the plurality of structures that house communication facilities. Further, there is a calculation unit that calculates an influence degree, in time-series, on communication due to communication facilities each housed in the plurality of structures when applying a condition assuming that the work to the communication facility, which is indicated in the plan that has been generated, has been performed, and calculates an index used for determining a target to which the work is actually preferentially performed based on a result obtained by discounting the influence degree according to a shortness of a period of time.

### TECHNICAL FIELD

An embodiment of the present invention relates to a network management device, a method, and a program.

### BACKGROUND ART

In order to maintain power supply, when a large-scale power outage occurs, to a communication facility of a building that provides communication to the outside by housing the communication facility (hereinafter, it may be referred to as a communication building or simply a building), a mobile power supply vehicle (hereinafter, it may be referred to as a power source vehicle) can be deployed to the communication building in which the communication facility is operated by an emergency battery (hereinafter, it may be simply referred to as a battery) due to the power outage (hereinafter, it may be referred to as a power outage building).

At this time, an operation manager of a network (NW) needs to determine a deployment plan indicating to which communication buildings the available mobile power supply vehicles are to be deployed by comprehensively determining the “importance” and the “urgency” of the communication buildings.

The above importance corresponds to the magnitude of the influence on the communication service when the remaining amount of the emergency battery in the communication building is exhausted, causing the function of the communication facility housed in the building to stop.

A lot of NWs have a redundant configuration, so that the influence on the communication service varies depending on the combination of the communication buildings of which functions stopped. Thus, it is desirable that the influence on the communication service be calculated in consideration of the NW configuration, and that a limited number of mobile power supply vehicles be deployed to a combination of buildings that minimizes this influence.

The above “urgency” refers to the shortness of the grace period until the remaining amount of the emergency battery in the communication building is exhausted.

In a communication building having a relatively shorter grace period until the remaining amount of the emergency battery is exhausted, the function of the communication facility stops at timing relatively earlier than that in a communication building having a relatively longer grace period. Consequently, the communication service may be affected for a longer period of time.

In addition, when a certain period of time has elapsed since the deployment plan was determined, there is a possibility that the communication building is restored to power and that the deployment of the power supply vehicle becomes unnecessary. Thus, the communication building having a relatively longer grace period until the remaining amount of the emergency battery is exhausted is less likely to actually affect the communication service compared with the communication building of which such a period of time is relatively shorter.

For this reason, it is desirable to deploy a limited number of power supply vehicles preferentially to the communication building having a relatively shorter grace period until the remaining amount of the emergency battery is exhausted.

For determining the deployment plan in consideration of the above “importance”, there is a technique of calculating an influence degree on the communication service when assuming that a part of a plurality of buildings in which a failure such as a power outage or the like has occurred has been restored from the failure, and outputting a combination that has a relatively smaller influence degree and can be restored with a limited number of vehicles.

For determining the deployment plan of a limited number of power supply vehicles in consideration of the above “urgency”, a method is conceivable in which power supply vehicles are deployed in order, starting from buildings having a relatively shorter period of time until the remaining amount of the battery is exhausted, to restore the buildings from a failure.

### CITATION LIST

### Non Patent Literature

Non Patent Literature 1: Syouhei NISHIKAWA, Masataka SATO, Kenji MURASE, Kimihiko FUKAMI, Kenichi TAYAMA, “Study on Method of Identifying Service Influence on Device Hierarchy”, THE INSTITUTE OF ELECTRONICS, INFORMATION AND COMMUNICATION ENGINEERS, IEICE Technical Report

### SUMMARY OF INVENTION

### Technical Problem

The above technique is for outputting a deployment plan in consideration of any one of the importance and the urgency of a communication building, and cannot output a deployment plan in consideration of these in a comprehensive manner.

Thus, in order to comprehensively judge the importance and the urgency of a communication building to determine a deployment plan, the NW operation manager determines the deployment plan based on two deployment plans output with conventional techniques, and the skill (experience) for the determination is required, accordingly.

The present invention has been made in view of the above circumstances, and an object thereof is to provide a network management device, a method, and a program capable of appropriately specifying a target to be restored from a communication failure when the communication failure occurs in a network configuration.

### Solution to Problem

A network management device according to an aspect of the present invention includes a generation unit that generates a plan of work for power supply to a communication facility housed in a part of a plurality of structures when applying a condition assuming that a power outage has occurred in the plurality of structures that house communication facilities, and a calculation unit that calculates an influence degree, in time-series, on communication due to communication facilities each housed in the plurality of structures when applying a condition assuming that the work to the communication facility, which is indicated in the plan generated by the generation unit, has been performed, and calculates an index used for determining a target to which the work is actually preferentially performed based on a result obtained by discounting the influence degree according to a shortness of a period of time from current time to a timing when the work to the communication facility, which is indicated in the plan, needs to be performed.

A network management method according to an aspect of the present invention performed by a network management device, the network management method includes generating a plan of work for power supply to a communication facility housed in a part of a plurality of structures when applying a condition assuming that a power outage has occurred in the plurality of structures that house communication facilities, calculating an influence degree, in time-series, on communication due to communication facilities each housed in the plurality of structures when applying a condition assuming that the work to the communication facility, which is indicated in the plan that has been generated, has been performed, and calculating an index used for determining a target to which the work is actually preferentially performed based on a result obtained by discounting the influence degree according to a shortness of a period of time from current time to a timing when the work to the communication facility, which is indicated in the plan, needs to be performed.

### Advantageous Effects of Invention

The present invention can appropriately specify a target to be restored from a communication failure when the communication failure occurs in a network configuration.

### BRIEF DESCRIPTION OF DRAWINGS

FIG. 1 is a diagram illustrating an application example of a network management device according to an embodiment of the present invention.

FIG. 2 is a flowchart illustrating an example of processing operation by the network management device according to the embodiment of the present invention.

FIG. 3 is a diagram illustrating an example of position information of power supply vehicles and power outage buildings.

FIG. 4 is a diagram indicating an example of current time and predicted failure occurrence time of each building in a tabular format.

FIG. 5 is a diagram indicating an example of various types of parameters in a tabular format.

FIG. 6 is a diagram illustrating an example of a deployment plan calculation result of the power supply vehicles for the buildings.

FIG. 7 is a diagram illustrating an examples of a deployment plan calculation result of the power supply vehicles for the buildings.

FIG. 8 is a diagram indicating an example of a calculation result of a comprehensive influence degree in a tabular format.

FIG. 9 is a block diagram illustrating an example of a hardware configuration of the network management device according to the embodiment of the present invention.

### DESCRIPTION OF EMBODIMENTS

Hereinafter, an embodiment according to the present invention will be described with reference to the drawings.

In the present embodiment, when assuming that a failure such as a power outage or the like occurs in a plurality of structures (in the present embodiment, a plurality of buildings) that house communication facilities, so that the power supply using emergency batteries to communication facilities housed in these buildings (hereinafter, it may be referred to as power supply to a building using an emergency battery or the like) starts due to stop of the power supply in a normal manner, and that as work to maintain or restore continuous power supply to communication facilities housed in a part of the plurality of buildings, mobile power supply vehicles are deployed to the buildings and the continuous power supply to the communication facilities housed in the buildings (hereinafter, it may be referred to as power supply to a building or the like) starts, the network management device calculates an influence degree, in time-series, on the communication service in the entire network by the communication facilities housed in the plurality of buildings due to the remaining buildings that houses the communication facilities to which the continuous power supply cannot be provided.

For example, when assuming that the mobile power supply vehicles are deployed in a building A, a building B, and a building C, which are a part of the plurality of buildings in which a failure such as a power outage has occurred, the network management device calculates, as influence degrees in time-series, the influence degree on the communication service after one hour, the influence degree on the communication service after two hours, . . . , and the influence degree on the communication service after T hours.

The network management device applies a time discount rate γ, which is a discount rate corresponding to the elapsed period of time, to each of the influence degrees in time-series calculated as described above, and calculates the sum of these as the comprehensive influence degree.

The comprehensive influence degree when assuming that the mobile power supply vehicles are deployed in the building A, the building B, and the building C can be calculated as Expression (1) below.

Comprehensive influence degree=Influence degree on communication service after one hour×Time discount rate γ¹+Influence degree on communication service after two hours×Time discount rate γ²+ . . . +Influence degree on communication service after T hours×Time discount rate γ^{T} Expression (1)

The network management device calculates the above comprehensive influence degree for each of combinations of the buildings in which the mobile power supply vehicles are deployed, and outputs a plan to deploy the power supply vehicles in a combination of the buildings having a relatively smaller comprehensive influence degree among the combinations.

According to the present embodiment, the deployment plan of the power supply vehicles in consideration of the importance and the urgency of the communication buildings in a comprehensive manner can be output, so that it is possible to realize the skill-less operation by the NW operation manager.

According to the present embodiment, the importance of communication buildings can be considered by calculating the time-series influence degrees on the communication service as described above, and the urgency of communication buildings can be considered by calculating and evaluating the comprehensive influence degree which is the total value after applying the time discount rate to the influence degrees calculated in time-series as described above.

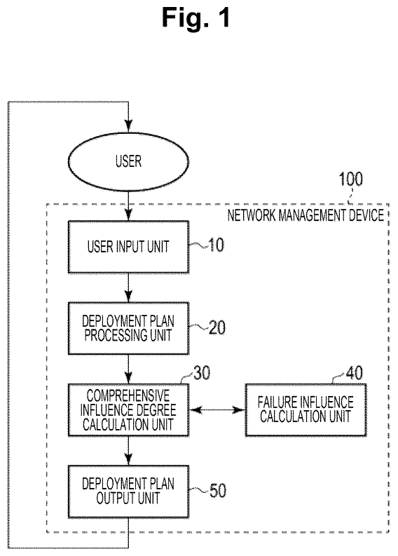

FIG. 1 is a diagram illustrating an application example of the network management device according to the embodiment of the present invention.

As illustrated in FIG. 1, a network management device 100 according to the embodiment of the present invention includes a user input unit 10, a deployment plan processing unit 20, a comprehensive influence degree calculation unit 30, a failure influence calculation unit 40, and a deployment plan output unit 50.

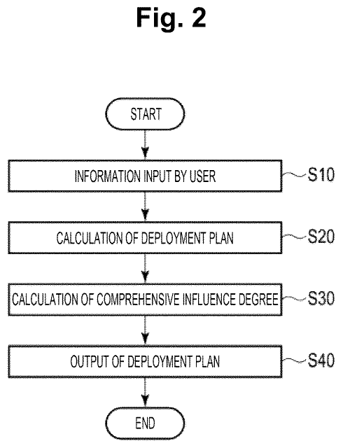

FIG. 2 is a flowchart illustrating an example of processing operation by the network management device according to the embodiment of the present invention.

First, the user input unit 10 receives information input by a user (S10).

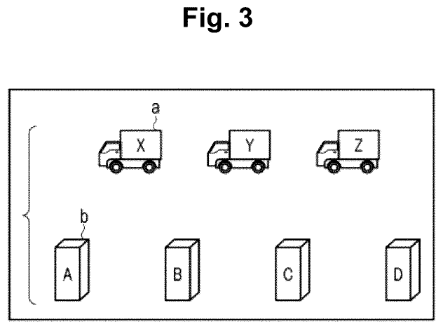

FIG. 3 is a diagram illustrating an example of position information of power supply vehicles and power outage buildings.

In S10, the user input unit 10 receives input, by the user, of the position information of a power supply vehicle (reference sign a in FIG. 3), the position information of a power outage building (reference sign b in FIG. 3), for example, the position information of power supply vehicles X, Y, and Z and the position information of power outage buildings A, B, C, and D as illustrated in FIG. 3. The position information is, for example, latitude and longitude.

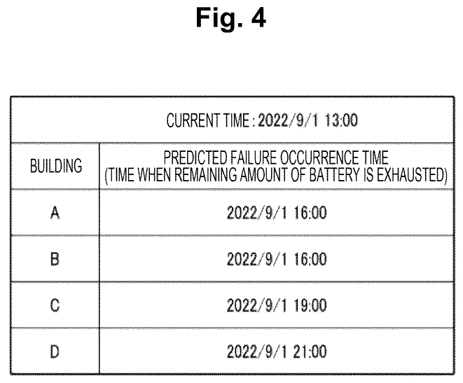

FIG. 4 is a diagram indicating an example of current time and predicted failure occurrence time of each building in a tabular format.

In S10, the user input unit 10 receives input, by the user, of the current time and the predicted failure occurrence time which is the predicted occurrence time of the communication failure in each building. The predicted failure occurrence time of a building is time when it is predicted that the remaining amount of the battery mounted in the building in which the power outage has occurred will be exhausted, that is, a timing when work to restore power supply from the failure needs to be performed on the communication facility housed in the building.

FIG. 4 illustrates an example in which it is expected that the remaining amount of the battery will be exhausted after three hours from the current time in the buildings A and B, it is expected that the remaining amount of the battery will be exhausted after six hours from the current time in the building C, and it is expected that the remaining amount of the battery will be exhausted after eight hours from the current time in the building D.

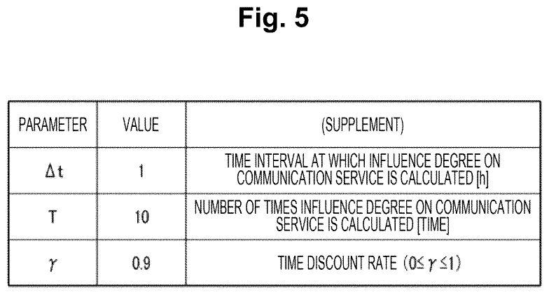

FIG. 5 is a diagram indicating an example of various types of parameters in a tabular format.

In S10, the user input unit 10 receives input, by the user, of various types of parameters. The parameters may be held in a storage device (not illustrated) as setting values, making the input by the user unnecessary.

As illustrated in FIG. 5, the various parameters include a time interval Δt for calculation of the influence degree on the communication service at the time of failure occurrence, the number of times T the influence degree on the communication service is calculated at the time of failure occurrence, and the time discount rate γ. In the example illustrated in FIG. 5, it means that the comprehensive influence degree is calculated based on the influence degree for each hour from one hour after to ten hours after, that is, the influence degrees in time-series of ten times.

Next, when assuming that the power supply vehicles are deployed in the part of the plurality of power outage buildings in which a failure accompanied by a power outage or the like occurs, the deployment plan processing unit 20 calculates the deployment plan indicating to which power outage buildings each power supply vehicle should be deployed, for example, using an existing solver (S20).

For example, the deployment plan processing unit 20 can calculate the deployment plan that minimizes the total moving distance of the power supply vehicles under the constraint condition that “one power supply vehicle can be deployed in only one power outage building”.

Note that an unachievable deployment combination of power supply vehicles in power outage buildings is not used for the calculation of the comprehensive influence degree.

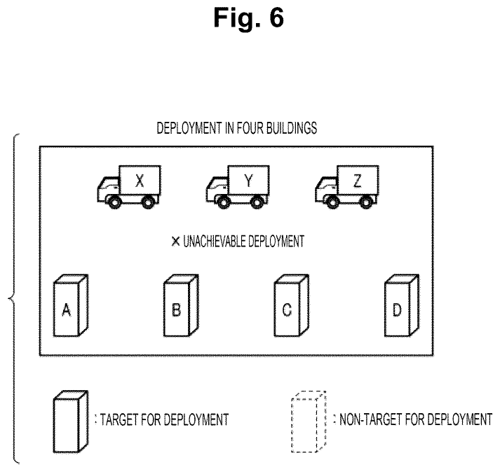

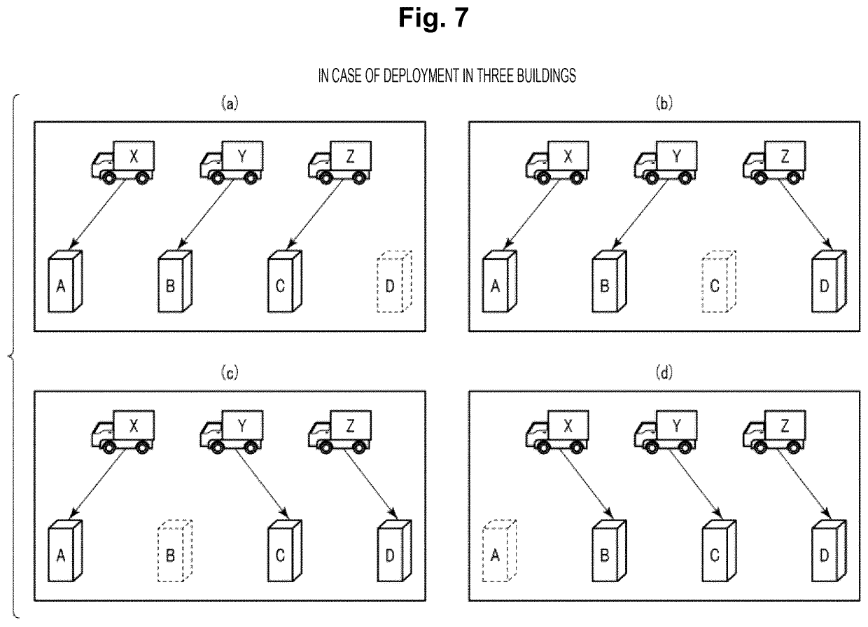

FIGS. 6 and 7 are diagrams illustrating examples of a deployment plan calculation result of the power supply vehicles for the buildings.

The example illustrated in FIG. 6 indicates that the three power supply vehicles X, Y, and Z cannot be deployed to all of the four power outage buildings A, B, C, and D that are the targets for deployment, that is, the deployment is unachievable. Note that the number of the power outage buildings that are the targets for deployment is larger than the number of the available power supply vehicles in the example illustrated in FIG. 6, so that it is obvious that the deployment is unachievable. Thus, the calculation of the deployment plan may be omitted due to the above constraint condition.

In addition, the examples illustrated in FIG. 7 indicate that the deployment plan processing unit 20 calculates a plan in which each of the three power supply vehicles X, Y, and Z is deployed one-to-one to the three power outage buildings that are the targets for deployment. In these deployment plan, it is assumed that any of the power supply vehicles can arrive before the remaining amount of the battery of the deployment destination building is exhausted.

(a) of FIG. 7 illustrates a plan in which the respective power supply vehicles X, Y, and Z are deployed one-to-one to the power outage buildings A, B, and C, and (b) of FIG. 7 illustrates a plan in which the respective power supply vehicles X, Y, and Z are deployed one-to-one to the power outage buildings A, B, and D.

(c) of FIG. 7 illustrates a plan in which the respective power supply vehicles X, Y, and Z are deployed one-to-one to the power outage buildings A, C, and D, and (d) of FIG. 7 illustrates a plan in which the respective power supply vehicles X, Y, and Z are deployed one-to-one to the power outage buildings B, C, and D.

Here, the plan examples in which the respective three power supply vehicles are deployed one-to-one to the three power outage buildings that are the targets for deployment has been described under the above constraint condition. However, when the number of the available power supply vehicles is equal to or larger than the number of buildings that are the targets for deployment, a plan in which, for example, two power supply vehicles among the three available power supply vehicles are deployed one-to-one to the two power outage buildings that are the targets for deployment under the above constraint condition may be calculated by the deployment plan processing unit 20.

The failure influence calculation unit 40 acquires information on the combination of buildings calculated by the deployment plan processing unit 20 as the deployment destination in the deployment plan of the power supply vehicles via the comprehensive influence degree calculation unit 30 or directly from the deployment plan processing unit 20, to calculate the influence degree on the communication service after a lapse of a predetermined period of time from the current time at the time interval that is received by the user input unit 10 as input, that is, the influence degree in time-series, by calculating the failure influence for each of predetermined evaluation items for the combination, and weighting and summing the calculated failure influence. This influence degree can be calculated based on a failure situation at that time by a known technique, for example, a technique of priority calculation described in PCT/JP2021/022172 specification. The above evaluation item is, for example, the number of users affected by the failure of a predetermined communication service.

The comprehensive influence degree calculation unit 30 calculates, based on the calculated influence degree, the comprehensive influence degree which is an index used for determining a target to which the work is actually preferentially performed, according to the following Expression (2), for each combination of buildings calculated as the deployment destination in the deployment plan of the power supply vehicles by the deployment plan processing unit 20, using the current time, the predicted time when the remaining amount of the battery of each power outage building becomes 0, and the above-described various parameters that have been received by the user input unit 10 as input (S30).

$$[ Math . 1 ]$$

$$COMPREHENSIVE INFLUENCE DEGREE = {\sum }_{t = Δ t}^{t = Δ t * T} {I}_{t} {γ}^{t} \qquad EXPRESSION ( 2 )$$

Iₜ: Influence degree on communication service after t hours
γ: Time discount rate (0≤γ≤1)

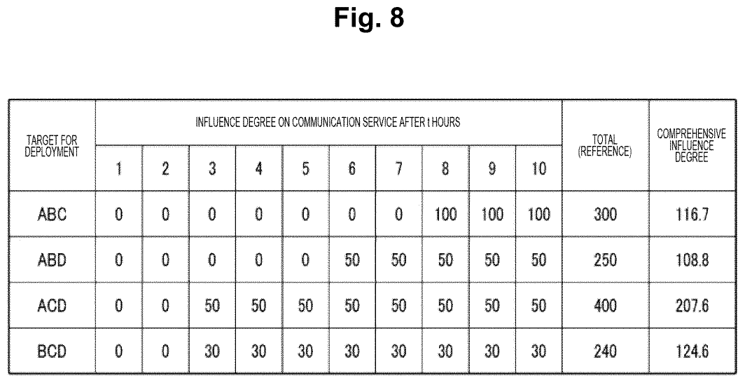

FIG. 8 is a diagram indicating an example of a calculation result of a comprehensive influence degree in a tabular format.

FIG. 8 illustrates an example of the comprehensive influence degree indicating the influence on the communication service by the communication facilities housed in the plurality of buildings including the above buildings A, B, C, and D and other buildings when assuming that power supply vehicles are deployed for each of a plurality of types of combinations (four patterns in the example) of three buildings among the buildings A, B, C, and D, which are candidates for the target for deployment of the power supply vehicles.

The example illustrated in FIG. 8 indicates that the comprehensive influence degree calculation unit 30 calculates, as the lowest comprehensive influence degree, the comprehensive influence degree when assuming that respective power supply vehicles are deployed in the buildings A, B, and D as compared with the comprehensive influence degree when assuming that the respective power supply vehicles are deployed in other types of combinations of buildings.

Next, the deployment plan output unit 50 determines, as preferential deployment destinations of the power supply vehicles, a combination having the lowest comprehensive influence degree among the comprehensive influence degrees obtained by calculation for each of the plurality of types of combinations of the buildings that are the targets for deployment by the comprehensive influence degree calculation unit 30, that is, determines the power supply facilities housed in the corresponding buildings as a target to which the above work is actually preferentially performed, and outputs a plan to deploy the power supply vehicle in the determined deployment destination.

In a case where the comprehensive influence degrees are calculated by the comprehensive influence degree calculation unit 30 as illustrated in FIG. 8, the deployment plan output unit 50 can output a plan to preferentially deploy the power supply vehicles in the targets for deployment, “the building A, the building B, and the building D”, having the lowest comprehensive influence degree “108.8”, in consideration of both the importance and the urgency described above.

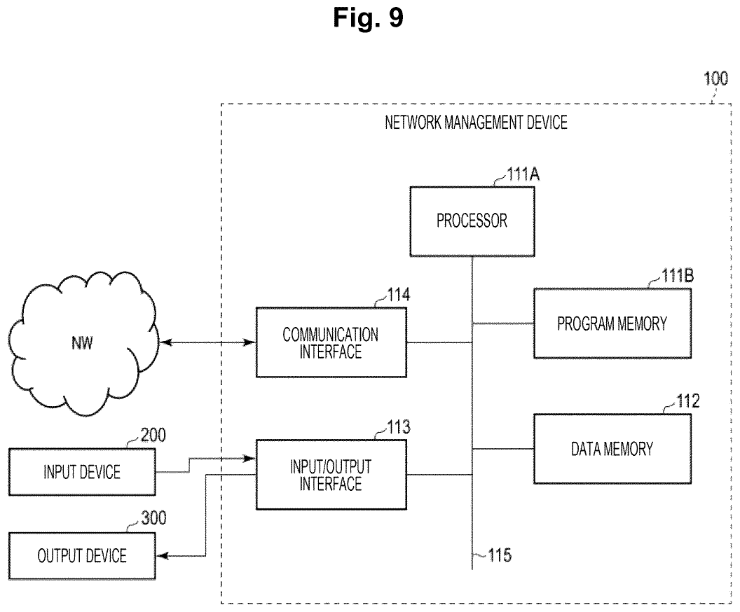

FIG. 9 is a block diagram illustrating an example of a hardware configuration of a network management device 100 according to the embodiment of the present invention.

In the example illustrated in FIG. 9, the network management device 100 according to the embodiment is configured with, for example, a server computer or a personal computer, and includes a hardware processor 111A such as a CPU. Then, a program memory 111B, a data memory 112, an input/output interface 113, and a communication interface 114 are connected to the hardware processor 111A via a bus 115.

The communication interface 114 includes, for example, one or more wireless communication interface units and enables transmission and reception of information to and from a communication network NW. As a wireless interface, for example, an interface in which a low-power wireless data communication standard is adopted, such as a wireless local area network (LAN), is used.

An input device 200 and an output device 300 that are attached to the network management device 100 and are used by a user or the like are connected to the input/output interface 113.

The input/output interface 113 performs processing of retrieving operation data input by the user or the like via the input device 200 such as a keyboard, a touch panel, a touchpad, or a mouse, and outputting output data to the output device 300 including a display device using liquid crystal, organic electro luminescence (EL), or the like to display the output data. Note that, as the input device 200 and the output device 300, a device built in the network management device 100 may be used, or an input device and an output device of another information terminal that can communicate with the network management device 100 via the network NW may be used.

The program memory 111B is used as a non-transitory tangible storage medium, for example, as a combination of a non-volatile memory on which writing and reading can be performed as necessary, such as a hard disk drive (HDD) or a solid state drive (SSD), and a non-volatile memory such as a read only memory (ROM), and stores programs necessary for executing various types of control processing and the like according to the embodiment.

The data memory 112 is used as a tangible storage medium, for example, as a combination of the above non-volatile memory and a volatile memory such as a random access memory (RAM) and is used to store various types of data acquired and created in a process in which various types of processing is performed.

The network management device 100 according to the embodiment of the present invention can be configured as a data processing device that includes a processing functional unit using software.

The storage device used as a work memory or the like by the network management device 100 can be configured by using the data memory 112 illustrated in FIG. 9. However, those configured storage areas are not essential configurations in the network management device 100 and may be provided in, for example, an external storage medium such as a universal serial bus (USB) memory or a storage device such as a database server arranged in a cloud.

The above processing functional unit can be implemented by causing the hardware processor 111A to read and execute a program stored in the program memory 111B. Note that the processing functional unit may be implemented in other various forms including an integrated circuit such as an application specific integrated circuit (ASIC) or a field-programmable gate array (FPGA).

In addition, the method described in the embodiment can be stored as a program (software means) that can be executed by a computing machine (computer), for example, in a recording medium such as a magnetic disk (such as a floppy (registered trademark) disk or a hard disk), an optical disc (such as a CD-ROM, a DVD, or a MO), or a semiconductor memory (such as a ROM, a RAM, or a flash memory), and can be distributed by being transmitted through a communication medium. Note that the programs stored in the medium also include a setting program for configuring, in the computing machine, a software means (including not only an execution program but also a table and a data structure) to be executed by the computing machine. The computing machine that implements the present device executes the above-described processing by reading the programs recorded in the recording medium, constructing the software means by the setting program as needed, and controlling operation by the software means. Note that the recording medium in the present specification is not limited to a recording medium for distribution, and includes a storage medium such as a magnetic disk or a semiconductor memory provided inside the computing machine or in a device connected via a network.

Note that the present invention is not limited to the above embodiment, and various modifications can be made at the implementation stage without departing from the gist of the invention. In addition, the embodiments may be implemented in an appropriate combination, and a combined effect can be obtained in such a case. The above embodiment include various inventions, and various inventions can be extracted through a combination selected from a plurality of disclosed components. For example, even if some components are deleted from all the components described in the embodiment, a configuration from which the components have been deleted can be extracted as an invention, as long as the issue can be solved and the effects can be achieved.

### REFERENCE SIGNS LIST

100 Network management device
10 User input unit
20 Deployment plan processing unit
30 Comprehensive influence degree calculation unit
40 Failure influence calculation unit
50 Deployment plan output unit

1. A network management device comprising:
generation circuitry that generates a plan of work for power supply to a communication facility housed in a part of a plurality of structures when applying a condition assuming that a power outage has occurred in the plurality of structures that house communication facilities; and
calculation circuitry that calculates an influence degree, in time-series, on communication due to communication facilities each housed in the plurality of structures when applying a condition assuming that the work to the communication facility, which is indicated in the plan generated by the generation circuitry, has been performed, and calculates an index used for determining a target to which the work is actually preferentially performed based on a result obtained by discounting the influence degree according to a shortness of a period of time from current time to a timing when the work to the communication facility, which is indicated in the plan, needs to be performed.

2. The network management device according to claim 1, wherein:
the generation circuitry generates a plan specifying a structure that is a target in which work to maintain or restore power supply to a communication facility housed in the structure is performed, which is a part of a plurality of structures when applying a condition assuming that due to occurrence of a power outage in the plurality of structures that house communication facilities, power supply using an emergency power supply facility to the communication facility starts, and
the calculation circuitry calculates an influence degree, in time-series, on communication due to the communication facilities each housed in the plurality of structures after current time when applying a condition assuming that the work to maintain or restore power supply to the communication facility housed in the structure that is the target in which the work is performed, which is indicated in the plan generated by the generation circuitry, and calculates the index based on a result obtained by discounting the influence degree according to a period of time from current time to a timing when power supply using the emergency power supply facility stops in a case where the work is not performed.

3. The network management device according to claim 1, wherein:
the generation circuitry generates a plan specifying a structure that serves as a deployment destination of a vehicle in which an equipment for power supply to a communication facility housed in a structure is mounted, which is a part of the plurality of structures when applying a condition assuming that a power outage has occurred in the plurality of structures, and
the calculation circuitry calculates an influence degree, in time-series, on communication due to the communication facilities each housed in the plurality of structures when applying a condition assuming that work for power supply to the communication facility housed in the structure that is the target of the work, which is indicated in the plan generated by the generation circuitry, using the equipment for power supply mounted in the vehicle that is deployed, and calculates the index based on a result obtained by discounting the influence degree according to a shortness of a period of time from current time to a timing when the work for power supply to the communication facility housed in the structure that is the target of the work needs to be performed.

4. The network management device according to claim 3, wherein:
the generation circuitry generates a plan specifying the structure that serves as the deployment destination as a plan in which a moving distance of the vehicle to the structure that serves as the deployment destination is minimized.

5. The network management device according to claim 1, wherein:
the generation circuitry generates, for each of a plurality of types of combinations, a plan of work for power supply to communication facilities housed in each of the plurality of types of combinations of multiple structures that are a part of a plurality of structures when applying a condition assuming that a power outage has occurred in the plurality of structures that house communication facilities;
the calculation circuitry calculates, for each of the plurality of types of combinations of the multiple structures, an influence degree, in time-series, on communication due to communication facilities housed in each of the plurality of types of combinations of the part of the plurality of structures when applying a condition assuming that the work to the communication facilities, which are indicated in the plan generated by the generation circuitry, has been performed, and calculates the index, for each of the plurality of types of combinations of the multiple structures, based on a result obtained by discounting the influence degree according to a shortness of a period of time from current time to a timing when the work to the communication facilities, which are indicated in the plan, needs to be performed; and
the network management device further includes a determination circuitry that determines, as targets to which the work is actually preferentially performed, communication facilities housed in a combination of the multiple structures when the influence on communication is smallest among the indexes that have been calculated.

6. A network management, comprising:
generating a plan of work for power supply to a communication facility housed in a part of a plurality of structures when applying a condition assuming that a power outage has occurred in the plurality of structures that house communication facilities;
calculating an influence degree, in time-series, on communication due to communication facilities each housed in the plurality of structures when applying a condition assuming that the work to the communication facility, which is indicated in the plan that has been generated, has been performed; and
calculating an index used for determining a target to which the work is actually preferentially performed based on a result obtained by discounting the influence degree according to a shortness of a period of time from current time to a timing when the work to the communication facility, which is indicated in the plan, needs to be performed.

7. The network management method according to claim 6, wherein:
the generating includes generating a plan specifying a structure that is a target in which work to maintain or restore power supply to a communication facility housed in the structure is performed, which is a part of a plurality of structures when applying a condition assuming that due to occurrence of a power outage in the plurality of structures that house communication facilities, power supply using an emergency power supply facility to the communication facility starts, and
the calculating includes calculating an influence degree, in time-series, on communication due to the communication facilities each housed in the plurality of structures after current time when applying a condition assuming that the work to maintain or restore power supply to the communication facility housed in the structure that is the target in which the work is performed, which is indicated in the plan that has been generated, and calculating the index based on a result obtained by discounting the influence degree according to a period of time from current time to a timing when power supply using the emergency power supply facility stops in a case where the work is not performed.

8. A non-transitory computer readable medium storing a network management processing program for causing a processor to perform the method of claim 7.
